(19) United States
(12) Patent Application Publication
(10) Pub. No.: US 2002/0124052 A1
(43) Pub. Date: Sep. 5, 2002

(54) Secure e-mail handling using a compartmented operating system

(76) Inventors: Richard Brown, Bristol (GB); Alex Chu, Bristol (GB); Christopher I. Dalton, Bristol (GB); Jonathan Griffin, Bristol (GB)

Correspondence Address: HEWLETT-PACKARD COMPANY, Intellectual Property Administration, P.O. Box 272400, Fort Collins, CO, 80527-2400, US

(21) Appl. No.: 10/075,444

(22) Filed: Feb. 15, 2002

(30) Foreign Application Priority Data
Feb. 17, 2001 (GB) 0103986.6

(51) Int. Cl. G06F 15/16

(52) U.S. Cl. 709/206

(57) ABSTRACT

An e-mail handling system stores e-mails 30 in separate compartments 241, 242. Highest risk e-mails are stored in individual compartments 242, while lower risk e-mails are stored together in one compartment 241 grouped according to any suitable characteristic such as the recipient or sender. An e-mail agent 27 examines each incoming e-mail according to a security policy. Stored e-mails are accessed by a combination of first and second browsers. The first browser 28 has cross compartment access to navigate the stored e-mails 30, while the second browser 29 is provided in the same compartment as a particular stored e-mail with access only to read within that compartment, 241, 242.

The present invention relates to the handling of e-mails in a secure manner on a computing platform having a compartmented operating system.

It is desired to increase security for a computing platform when handling e-mails. E-mails are a common source of infection passing viruses into a previously secure computing platform. Many virus checking methods are known, but these generally rely on some form of database which must be updated regularly in order to be effective. Therefore, there is a high degree of ongoing maintenance in most virus checking methods. As an alternative or additional to virus checking, it is desired to limit the amount of damage that can be done to a computing platform when handling e-mails.

An aim of the present invention is to provide a method and apparatus for secure handling of e-mails. A preferred aim is to provide a method and apparatus where the effects of a malicious e-mail such as a virus can be contained.

According to first aspect of the present invention there is provided an e-mail handling method, comprising the step of: storing an e-mail in a compartment of a compartmented operating system.

Preferably, the method comprises storing an e-mail in a compartment with other e-mails, or alternatively in an individual compartment. Preferably, the method comprises assessing the e-mail according to a security policy, and preferably determining a security status for the e-mail. Preferably, the method comprises applying a security tag to the e-mail denoting the determined security status.

Preferably, the method comprises determining a security status for the e-mail, and storing the e-mail either in an individual compartment or in a compartment containing plural e-mails, according to the determined security status.

According to a second aspect of the present invention there is provided an e-mail handling apparatus, comprising an e-mail agent for storing an e-mail in a compartment of a compartmented operating system.

Preferably, the e-mail agent stores the e-mail in a compartment with other e-mails, or in an individual compartment. Preferably, the e-mail agent applies a security tag denoting a security status of the e-mail. Preferably, the e-mail agent determines a security status of the e-mail and stores the e-mail either in a compartment with other e-mails or an individual compartment according to the determined security status.

According to a third aspect of the present invention there is provided an e-mail handling method comprising the steps of: (a) navigating to an e-mail stored in a compartment; and (b) opening the e-mail within the compartment.

Preferably, the step (a) comprises navigating to the stored e-mail using a first browser. Preferably, the first browser is provided outside the compartment where the e-mail is stored. Preferably, the first browser is able only to navigate to e-mails across compartments.

Preferably, the step (b) comprises providing a second browser within the compartment where the e-mail is stored. Preferably, the second browser is given permission to read an e-mail within the compartment.

Preferably, the method comprises the step (c) of applying a security status to the stored e-mail.

Preferably, the method comprises the step (d) of moving the e-mail to a new compartment consistent with the applied security status.

According to a fourth aspect of the present invention there is provided an e-mail handling apparatus, comprising: a compartment of a compartmented operating system for storing an e-mail; a first browser provided outside the compartment for navigating to the e-mail; and a second browser provided within the compartment for accessing the e-mail.

Preferably, the second browser is spawned by the first browser in response to navigating to the stored e-mail. Preferably, the first browser is able only to navigate to e-mails across compartments. Preferably, the second browser is only able to access the e-mail within the compartment. Preferably, the second browser is denied access outside the compartment. Preferably, the e-mail is one of many stored in the same compartment. Preferably, the e-mail is one of many each stored in an individual compartment.

For a better understanding of the invention, and to show how embodiments of the same may be carried into effect, reference will now be made, by way of example, to the accompanying diagrammatic drawings in which:

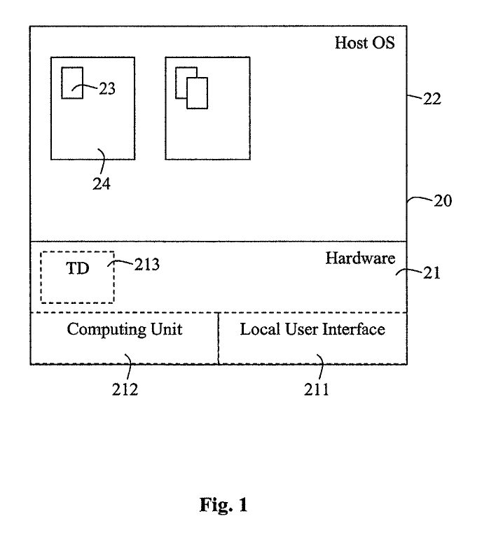

FIG. 1 shows a preferred computing platform;

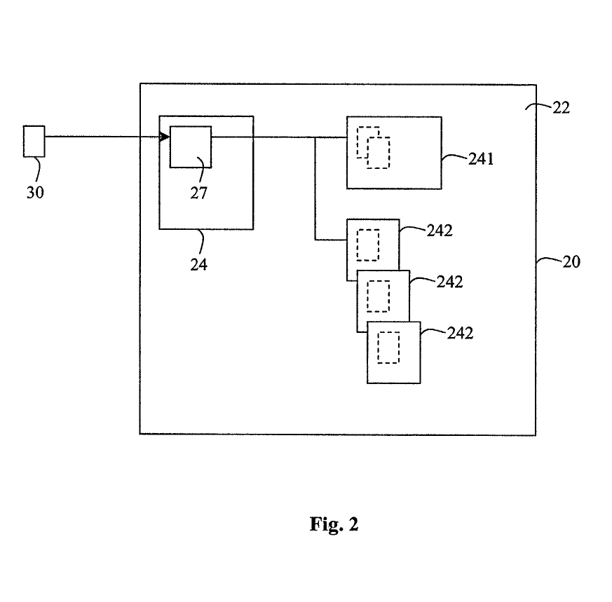

FIG. 2 shows a preferred e-mail handling apparatus;

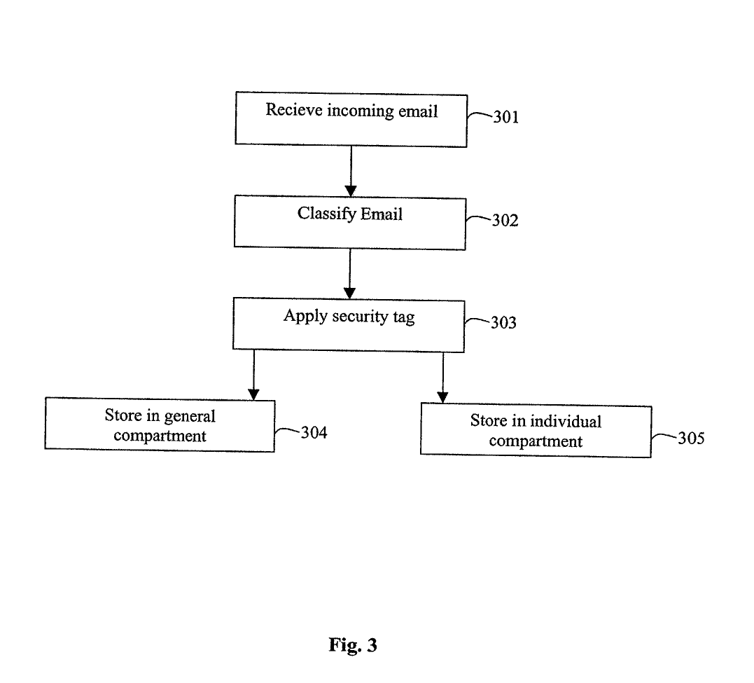

FIG. 3 shows a preferred method for handling e-mails;

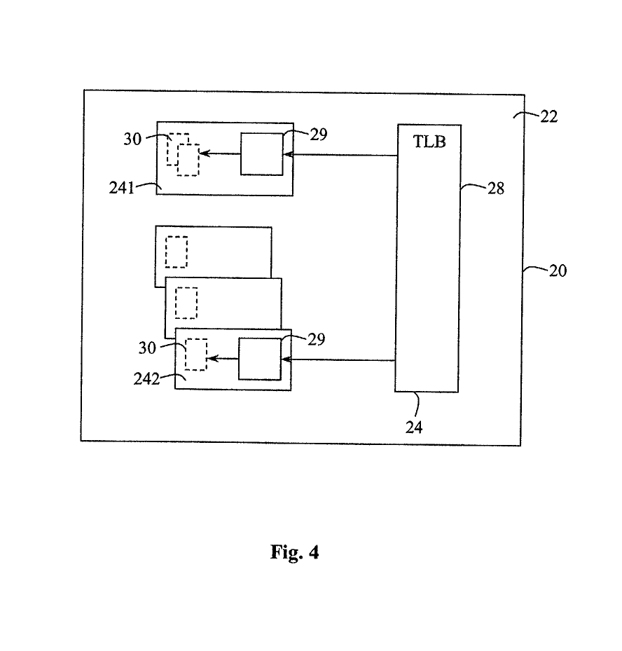

FIG. 4 shows another preferred apparatus for handling e-mails; and

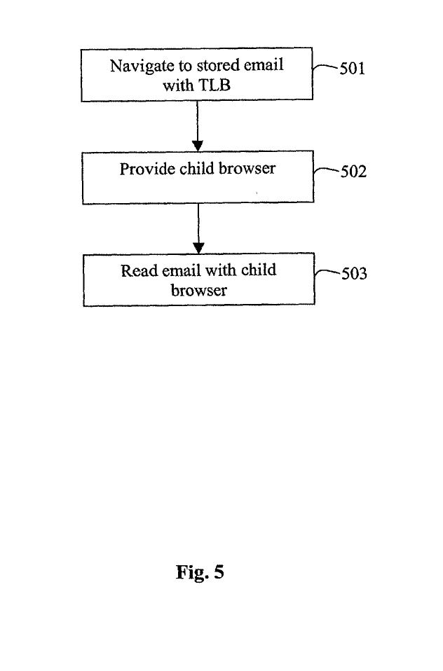

FIG. 5 shows another preferred method for handling e-mails.

FIG. 1 shows an example computing platform 20 employed in preferred embodiments of the present invention. The computing platform 20 comprises hardware 21 operating under the control of a host operating system 22. The hardware 21 may include standard features such as a keyboard, a mouse and a visual display unit which provide a physical user interface 211 to a local user of the computing platform. The hardware 21 also suitably comprises a computing unit 212 including a main processor, a main memory, an input/output device and a file storage device which together allow the performance of computing operations. Other parts of the computing platform are not shown, such as connections to a local or global network. This is merely one example form of computing platform and many other specific forms of hardware are applicable to the present invention.

In one preferred embodiment the hardware 21 includes a trusted device 213. The trusted device 213 functions to bind the identity of the computing platform 20 to reliably measured data that provides an integrity metric of the platform and especially of the host operating system 22. WO 00/48063 (Hewlett-Packard) discloses an example trusted computing platform suitable for use in preferred embodiments of the present invention.

Referring to FIG. 1, the host operating system 22 runs a process 23. In practical embodiments, many processes run on the host operating system simultaneously. Some processes are grouped together to form an application or service. For simplicity, a single process will be described first, and the invention can then be applied to many processes and to groups of processes.

In the preferred embodiment, the process 23 runs within a compartment 24 provided by the host operating system 22. The compartment 24 serves to confine the process 23, by placing strict controls on the resources of the computing platform available to the process, and the type of access that the process 23 has to those resources. Advantageously, controls implemented in the kernel are very difficult to override or subvert from user space by a user or application responsible for running the process 23.

Compartmented operating systems have been available for several years in a form designed for handling and processing classified (military) information, using a containment mechanism enforced by a kernel of the operating system with mandatory access controls to resources of the computing platform such as files, processes and network connections. The operating system attaches labels to the resources and enforces a policy which governs the allowed interaction between these resources based on their label values. Most compartmentalised operating systems apply a policy based on the Bell-LaPadula model discussed in the paper “Applying Military Grade Security to the Internet” by C I Dalton and J F Griffin published in Computer Networks and ISDN Systems 29 (1997) 1799-1808.

The preferred embodiment of the present invention adopts a simple and convenient form of operating system compartment. Each resource of the computing platform which it is desired to protect is given a label indicating the compartment to which that resource belongs. Mandatory access controls are performed by the kernel of the host operating system to ensure that resources from one compartment cannot interfere with resources from another compartment. Access controls can follow relatively simple rules, such as requiring an exact match of the label. Examples of resources include data structures describing individual processes, shared memory segments, semaphores, message queues, sockets, network packets, network interfaces and routing table entries.

Communication between compartments is provided using narrow kernel level controlled interfaces to a transport mechanism such as TCP/UDP. Access to these communication interfaces is governed by rules specified on a compartment by compartment basis. At appropriate points in the kernel, access control checks are performed such as through the use of hooks to a dynamically loadable security module that consults a table of rules indicating which compartments are allowed to access the resources of another compartment. In the absence of a rule explicitly allowing a cross compartment access to take place, an access attempt is denied by the kernel. The rules enforce mandatory segmentation across individual compartments, except for those compartments that have been explicitly allowed to access another compartment's resources. Communication from a compartment to a network resource is provided in a similar manner. In the absence of an explicit rule, access between a compartment and a network resource is denied.

Suitably, each compartment is allocated an individual section of a file system of the computing platform. For example, the section is a chroot of the main file system. Processes running within a particular compartment only have access to that section of the file system. Advantageously, through kernel controls, the process is restricted to the predetermined section of file system and cannot escape. In particular, access to the root of the file system is denied.

Advantageously, a compartment provides a high level of containment, whilst reducing implementation costs and changes required in order to implement an existing application within the compartment.

Referring to FIG. 2, a preferred arrangement of the computing platform will now be described for use when receiving a new e-mail 30.

Suitably, a new e-mail 30 is received from an outside source such as through connections to a local computer network or a global computer network like the internet. Preferably, incoming e-mails are handled by an e-mail agent 27 which is an application or service running within a compartment 24 of the host operating system 22 of the computing platform 20.

The e-mail agent 27 stores the incoming e-mail 30 in a compartment. In a first preferred embodiment all incoming e-mails are held together in one compartment 241. The compartment 241 provides a high degree of isolation protecting the rest of the computing platform from the effects of the incoming e-mails. In a second preferred embodiment providing an even higher degree of security, each e-mail is stored in a separate individual compartment 242. Other preferred embodiments are possible. For example, e-mails are grouped according to the sender or according to the recipient or according to any other predetermined characteristic.

Preferably, the e-mail agent 27 makes an assessment of the security risk presented by the new e-mail 30. Preferably, this assessment is made according to a security policy determined, for example, by a human administrator of the computing platform. In one example embodiment the security policy assumes that all e-mails from an unknown source are untrustworthy and should be placed in a high risk security category. In another example, all e-mails with executable attachments (such as .exe files) are considered high risk. E-mails from a known and previously trusted source are placed for example in a medium risk category or a low risk category. Any suitable security policy can be used.

Preferably, the e-mail agent 27 applies a security tag to the incoming e-mail 30. Preferably, the security tag is applied to e-mails which are considered high risk. Alternatively, the security tag is applied to all incoming e-mails and denotes one of many predetermined levels of risk associated with that e-mail.

Referring to FIG. 3, a preferred method for handling incoming e-mails will now be described. In step 301 an incoming e-mail 30 is received, such as by the e-mail agent 27.

In step 302 the e-mail is classified such as by being given a security status. Preferably, the e-mail is classified according to a perceived threat to security of the computing platform, based on any suitable characteristic of the e-mail. Preferably, the e-mail is given one security status amongst many, according to a predetermined security policy.

Optionally, in step 203 a security tag is applied. Preferably, a security tag is applied to all incoming e-mails denoting a predetermined level of risk. Suitably, in the absence of a match with specific criteria of a security policy, a default status is applied, such as a high-risk status.

In step 304 the e-mail is stored in a compartment containing incoming e-mails. Preferably, plural e-mails are stored together in the same compartment 241.

Alternatively, in step 305 the e-mail is stored in an individual compartment. Preferably, each incoming high risk e-mail is stored in an individual compartment 242.

FIG. 4 shows a second preferred apparatus for handling e-mails.

The apparatus of FIG. 4 allows stored e-mails to be accessed securely. A first e-mail browser 28 is provided as a top level browser. The top level browser 28 is provided in a compartment 24. The top level browser 28 is given permission only to navigate to find the location of stored e-mails 30, but is not given permission to read e-mails. Therefore, the top level browser can be given quite extensive cross compartment privileges, but it is difficult to subvert these privileges because the top level browser 28 cannot read any of the stored e-mails 30.

Preferably, the top level browser 28 is designed only to be able to navigate and locate e-mails. For example, the top level browser 28 is only able to read header information such as “subject” and “from” fields, but not a message body. Preferably, the top level browser 28 is unable to access the message body of an e-mail. Advantageously, the top level browser having very limited functionality is relatively easy to implement in practice and is less likely to suffer errors such as coding bugs. Preferably, the top level browser is designed specifically to perform these navigation and location tasks, giving a high degree of security.

When a desired e-mail has been located by the top level browser 28, a child browser 29 is spawned. This second browser is preferably provided within the same compartment 241, 242 as the stored e-mail 30 which it is desired to access. The child browser 29 is restricted to the compartment, and any cross compartment privileges given to the child browser 29 are very limited. Therefore, an attack on the child browser 29 by an e-mail 30 is contained by the compartment 241, 242. Preferably, the child browser 29 is given permission only to read e-mails. Preferably, a new child browser 29 is provided each time a stored e-mail is accessed. Alternatively, the child browser 29 is given permission to access all e-mails stored within a particular compartment 241.

Preferably, a user can alter the security status of an e-mail 30 once it has been read. Ideally, altering the security status is controlled by a system security policy and/or by user access controls. For example, an e-mail placed in an individual compartment 242 may, once read, be considered as a relatively low risk and can be moved to join a collection of general e-mails in another compartment 241. Preferably, the move operation is performed by the top level browser 28, or by the e-mail agent 27. Once moved, a new child browser 29 is provided in order to read the e-mail within its new compartment.

Whilst the e-mail agent 27 and the top level browser 28 have been described as separate components, in practical implementations these can be combined into a single application or service. Preferably, the e-mail agent 27 and the top level browser 28 are separate groups of processes each with different privileges each in separate compartments of the computing platform.

FIG. 5 shows a second preferred method for handling e-mails.

In step 501 a first browser is used to navigate to a stored e-mail. Preferably, the top level browser 28 navigates to a stored e-mail 30 in a particular compartment 241, 242.

In step 502 a second browser is provided within the same compartment as the e-mail. Preferably, a child browser 29 is provided in the same compartment 241, 242 as the stored e-mail 30.

In step 503 the e-mail is accessed using the second browser. Preferably, the child browser 29 is given read access to the stored e-mail 30 within that compartment 241, 242.

A method and apparatus have been described allowing incoming e-mails to be stored within compartments, preferably according to a security policy. In one embodiment each e-mail is stored in a separate individual compartment giving a very high level of security and isolation for each e-mail. In another embodiment incoming e-mails are stored together in a general compartment, which provides a good level of security and isolation for the remainder of the computer platform. In a second aspect stored e-mails are accessed using a combination of first and second browsers. The first browser is allowed only to navigate to stored e-mails across different compartments, whilst the second browser has read access only within the same compartment as a desired stored e-mail. Therefore, an attack on the e-mail browsers by an e-mail is restricted to the relevant compartment. It is very difficult for an e-mail to subvert the restrictions of the compartment and escape to affect any other parts of the computing platform.

1. An e-mail handling method, comprising the step of:
storing an e-mail in a compartment of a compartmented operating system.

2. The method of claim 1, comprising storing an e-mail in a compartment with other e-mails.

3. The method of claim 1, wherein the e-mail is stored in an individual compartment.

4. The method of claim 1, comprising assessing the e-mail according to a security policy.

5. The method of claim 1, comprising determining a security status for the e-mail.

6. The method of claim 5, comprising applying a security tag to the e-mail denoting the security status.

7. The method of claim 1, comprising determining a security status for the e-mail, and storing the e-mail either in an individual compartment or in a compartment for containing plural e-mails, according to the determined security status.

8. An e-mail handling apparatus, comprising:
an e-mail agent for storing an e-mail in a compartment of a compartmented operating system.

9. The apparatus of claim 8, wherein the e-mail agent stores the e-mail in a compartment with other e-mails.

10. The apparatus of claim 8, wherein the e-mail agent stores the e-mail in an individual compartment.

11. The apparatus of claim 8, wherein the e-mail agent applies a security tag denoting a security status of the e-mail.

12. The apparatus of claim 8, wherein the e-mail agent determines a security status of the e-mail and stores the e-mail either in a compartment with other e-mails or in an individual compartment according to the determined security status.

13. An e-mail handling method comprising the steps of:
(a) navigating to an e-mail stored in a compartment; and
(b) opening the e-mail within the compartment.

14. The method of claim 13, wherein the step (a) comprises navigating to the stored e-mail using a first browser.

15. The method of claim 14, wherein the first browser is provided outside the compartment where the e-mail is stored.

16. The method of claim 15, wherein the first browser is able only to navigate to e-mails across compartments.

17. The method of claim 13, wherein the step (b) comprises providing a second browser within the compartment where the e-mail is stored.

18. The method of claim 17, wherein the second browser is given permission to read an e-mail within the compartment.

19. The method of claim 13, comprising the step (c) of applying a security status to the stored e-mail.

20. The method of claim 19, comprising the step (d) of moving the e-mail to a new compartment consistent with the applied security status.

21. An e-mail handling apparatus, comprising:
a compartment of a compartmented operating system for storing an e-mail;
a first browser provided outside the compartment for navigating to the e-mail; and
a second browser provided within the compartment for accessing the e-mail.

22. The e-mail handling apparatus of claim 21, wherein the second browser is spawned by the first browser in response to navigating to the stored e-mail.

23. The e-mail handling apparatus of claim 21, wherein the first browser is only able to navigate to e-mails across compartments.

24. The e-mail handling apparatus of claim 21, wherein the second browser is only able to access the e-mail within the compartment.

25. The e-mail handling apparatus of claim 24, wherein the second browser is denied access outside the compartment.

26. The e-mail handling apparatus of claim 21, wherein the e-mail is one of many stored in the same compartment.

27. The e-mail handling apparatus of claim 21, wherein the e-mail is one of many each stored in an individual compartment.
